(19) United States
(12) Patent Application Publication
(10) Pub. No.: US 2023/0045480 A1
(43) Pub. Date: Feb. 9, 2023

(54) BLADE NOISE REDUCTION DEVICE

(71) Applicant: SEOUL NATIONAL UNIVERSITY R&DB FOUNDATION, Seoul (KR)

(72) Inventors: Soo Gab LEE, Seoul (KR); Dong Yeon HAN, Seoul (KR)

(21) Appl. No.: 17/758,278

(22) PCT Filed: Mar. 10, 2020
(86) PCT No.: PCT/KR2020/003311

§ 371 Date: Jun. 30, 2022

(30) Foreign Application Priority Data
Dec. 30, 2019 (KR) 10-2019-0178536

(51) Int. Cl. F03D 80/00; F03D 1/06

(52) U.S. Cl. CPC F03D 80/00; F03D 1/0633

(57) ABSTRACT

The present disclosure relates to a blade noise reduction apparatus arranged at a trailing edge of a blade and reducing noise during rotation of the blade. The blade noise reduction apparatus includes an attachment unit combined with the trailing edge of the blade, and a sawtooth unit formed to protrude in a longitudinal direction of the attachment unit from the attachment unit, wherein the sawtooth unit includes a lower sawtooth unit including first sawteeth repeatedly arranged thereon, and an upper sawtooth unit including a second sawtooth having a length less than a length of the first sawtooth and arranged on an upper surface of each first sawtooth.

### TECHNICAL FIELD

The present disclosure relates to a blade noise reduction apparatus, and more particularly, to a blade noise reduction apparatus for reducing noise generated at a trailing edge of a blade by using multiple sawteeth.

### BACKGROUND ART

When a wind power generator is operating, aerodynamic noise is generated due to the interaction between a rotating blade of the wind power generator and air. It is known that among aerodynamic noise, a turbulent boundary layer trailing edge noise, which is generated when vortex components in a turbulent boundary layer formed on a surface of a rotating blade are scattered by a trailing edge of the rotating blade, is the main noise.

To reduce the turbulent boundary layer trailing edge noise caused by the blade, a method of attaching a sawtooth-shaped structure to the trailing edge of the rotating blade has been proposed. By using the method described above, it is possible to reduce the noise by reducing the magnitude of vortices formed by decomposition of the air flowing toward the trailing edge of the blade.

However, even when the magnitude of the vortices is reduced, the vortices themselves do not disappear, and accordingly, there is a limit in noise reduction. Thus, the present disclosure provides a blade noise reduction apparatus capable of maximizing the noise reduction by extinguishing the vortices.

### DESCRIPTION OF EMBODIMENTS

### Technical Problem

The present disclosure is proposed to improve the issues described above, and provides a blade noise reduction apparatus for reducing blade noise by decomposing vortices generated at a trailing edge of a blade in a fine manner by using multiple sawteeth and offsetting the decomposed vortices.

### Solution to Problem

According to the present disclosure, the blade noise reduction apparatus arranged at a trailing edge of a blade to reduce noise during rotation of the blade includes an attachment unit combined with the trailing edge of a blade, and a sawtooth unit formed to protrude in a longitudinal direction of the attachment unit from the attachment unit, wherein the sawtooth unit includes a lower sawtooth unit including first sawteeth repeatedly arranged thereon, and an upper sawtooth unit including a second sawtooth having a length less than a length of the first sawtooth and arranged on an upper surface of each first sawtooth.

The second sawtooth may include a multi-sawteeth formed by at least two repeating identical sawteeth.

A length of the attachment unit may be greater than or equal to about 1/10 of a chord length of the blade.

A thickness of the attachment unit may be within a range of about 1/1000 to about 1/100 of the chord length of the blade.

The attachment unit may include an inclined surface extending by a certain angle from one end portion of an attachment surface contacting the trailing edge of the blade, and the certain angle formed between the inclined surface and the attachment surface may be within a range of about 8° to about 11°.

The length of the first sawtooth may be equal to the length of the attachment unit.

The length of the second sawtooth may be about 4/10 to about 6/10 of the length of the first sawtooth.

An interval between the second sawteeth may be within about 3/10 of the length of the first sawtooth.

Each first sawtooth may include a first attachment unit contacting the attachment unit and a first protrusion unit protruding from the first attachment unit in a triangle shape, and the second sawtooth may include a left sawtooth in a triangle shape of which vertex is arranged on one side edge of the first protrusion unit, and a right sawtooth in a triangle shape of which vertex is arranged on the other side edge of the first protrusion unit.

The left sawtooth and the right sawtooth may each have an isosceles triangle shape.

### BRIEF DESCRIPTION OF DRAWINGS

FIG. 1 is a cross-sectional view of a blade.

FIG. 2 is a perspective view of a configuration, in which a blade noise reduction apparatus is arranged at a trailing edge of a blade, according to an embodiment of the present disclosure.

FIG. 3 is a perspective view of a blade noise reduction apparatus according to an embodiment of the present disclosure.

FIG. 4 is a diagram illustrating an excerpt of a main portion in FIG. 3.

FIG. 5 is a diagram illustrating decomposition patterns of vortices.

FIG. 6 is a diagram illustrating reduction patterns of vortices.

FIG. 7 is a table of experimental data obtained by applying embodiments of the present disclosure to a trailing edge of a blade.

FIG. 8 is a graph representing the table of FIG. 7.

FIG. 9 is a diagram illustrating a case, in which a shape of an upper sawtooth portion is not an isosceles triangle.

### MODE OF DISCLOSURE

Hereinafter, embodiments according to the present disclosure will be described in detail with reference to the accompanying drawings.

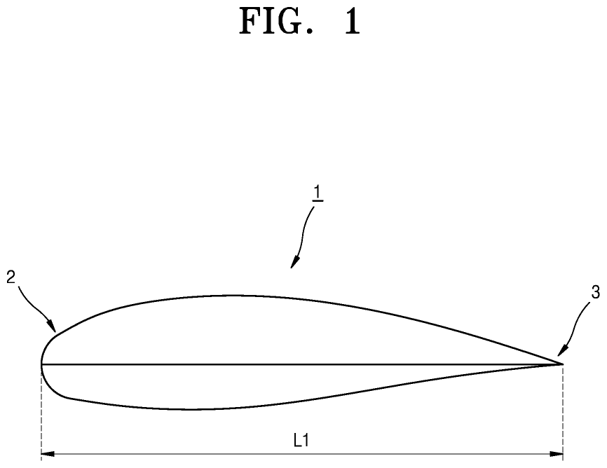

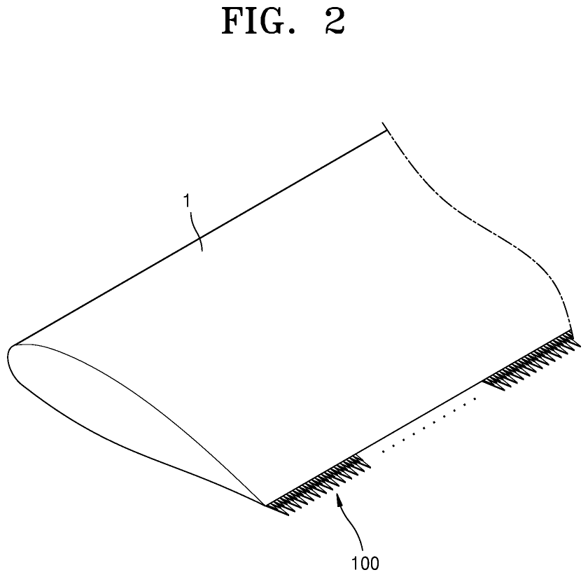

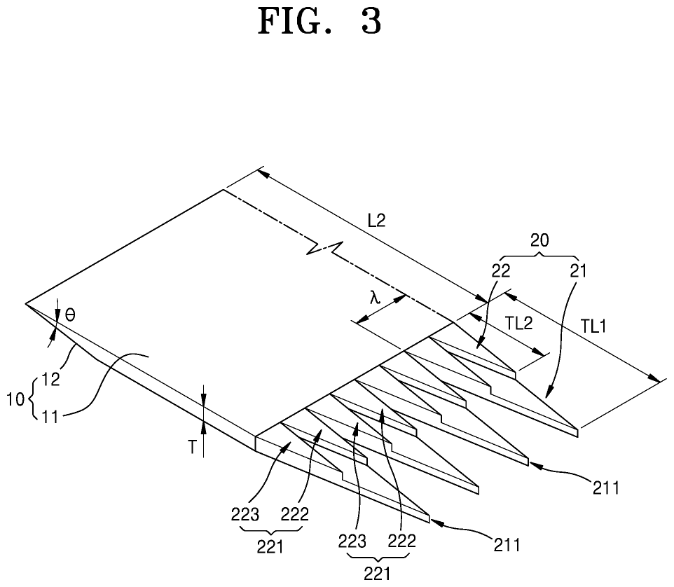

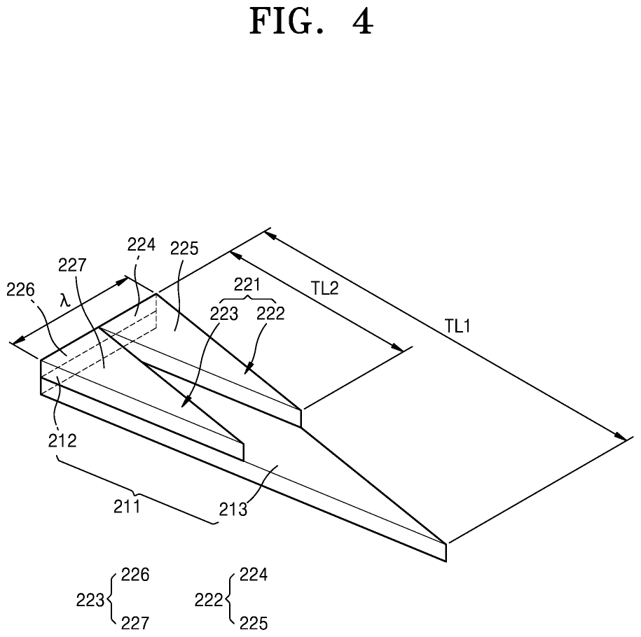

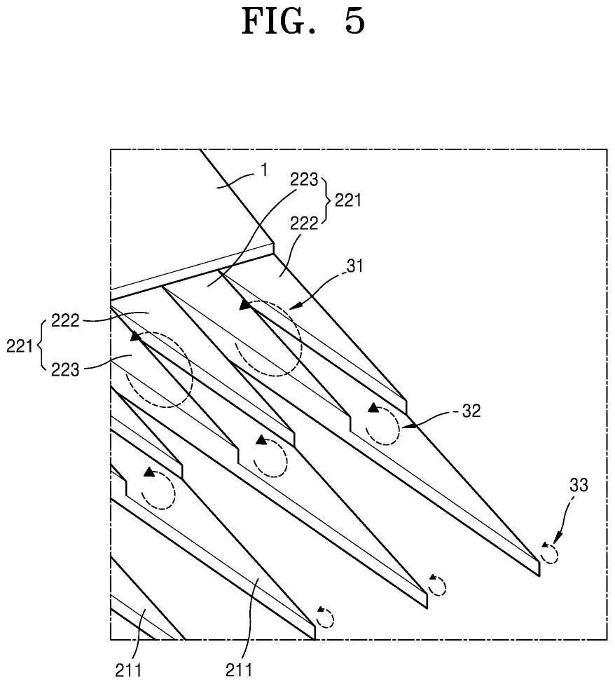

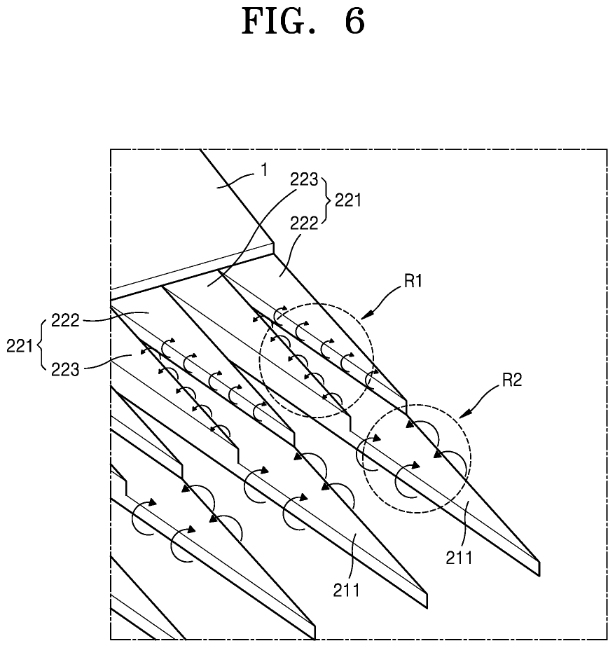

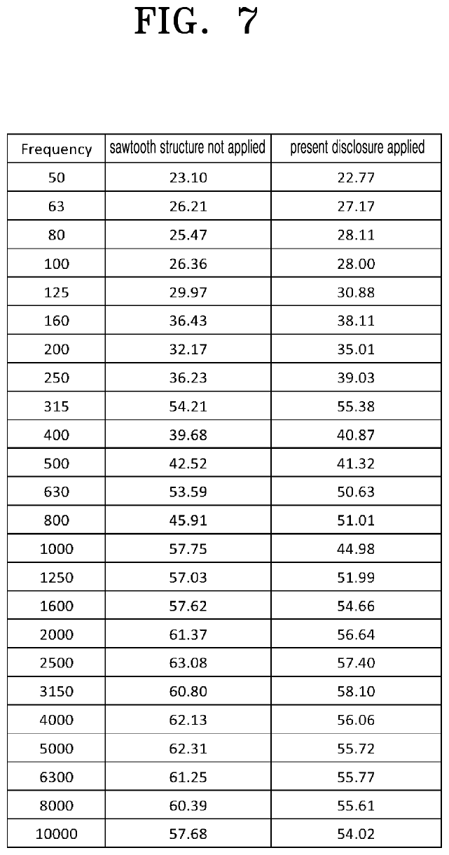

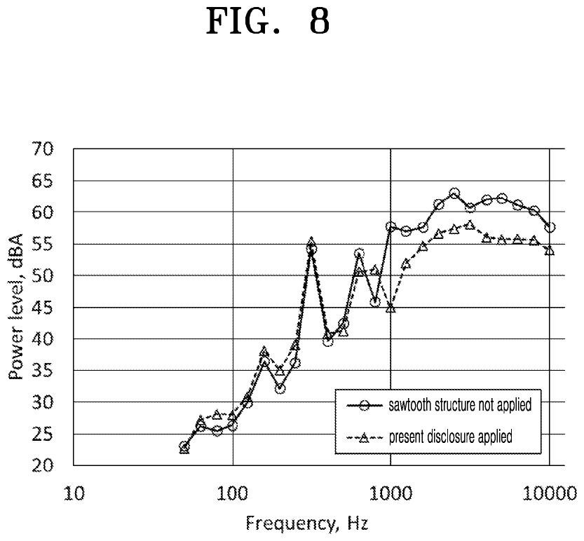

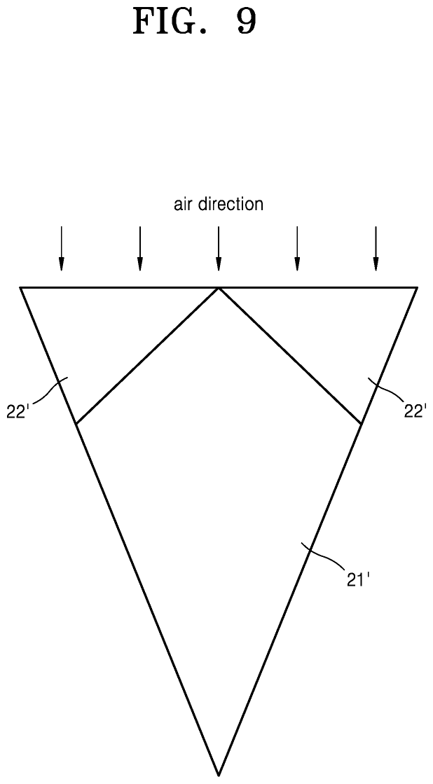

FIG. 1 is a cross-sectional view of a blade, and FIG. 2 is a perspective view of a configuration, in which a blade noise reduction apparatus is arranged at a trailing edge of a blade, according to an embodiment of the present disclosure. FIG. 3 is a perspective view of a blade noise reduction apparatus according to an embodiment of the present disclosure. FIG. 4 is a diagram illustrating an excerpt of a main portion in FIG. 3, FIG. 5 is a diagram illustrating decomposition patterns of vortices, and FIG. 6 is a diagram illustrating reduction patterns of the vortices. FIG. 7 is a table of experiment data obtained by applying embodiments of the present disclosure to a trailing edge of a blade, and FIG. 8 is a graph representing the table of FIG. 7. FIG. 9 is a diagram illustrating a case, in which a shape of an upper sawtooth portion is not an isosceles triangle.

A blade noise reduction apparatus 100 according to an example embodiment of the present disclosure is related to an apparatus, for reducing noise at the time of rotation of a blade 1, arranged at a trailing edge 3 of the blade 1. As illustrated in FIG. 1, the blade 1 may be divided into a leading edge 2 colliding with the air, a streamlined surface along which the air flows, and the trailing edge 3, from which the air is separated. The blade noise reduction apparatus 100 of the present disclosure may, as illustrated in FIG. 2, be related to an apparatus, which is attached to the trailing edge 3 of the blade 1 and reduces noise due to the air separated from the blade 1.

As illustrated in FIG. 3, the blade noise reduction apparatus 100 according to the present disclosure may include an attachment unit 10 and a sawtooth unit 20.

The attachment unit 10 may be combined to the trailing edge 3 of the blade 1. According to the embodiment, the attachment unit 10 may be attached to a lower surface of the trailing edge 3 of the blade 1. A length L2 of the attachment unit 10 may be about 1/10 or more of a chord length L1 of the blade 1.

The length L2 of the attachment unit 10 may be arranged in a range described above, and stably attached to the trailing edge 3 of the blade 1. When the length L2 of the attachment unit 10 is formed as about 1/10 or less of the chord length L1 of the blade 1, it may be possible that the attachment unit 10 can be detached from the blade 1.

In addition, according to the embodiment, a thickness T of the attachment unit 10 may be defined in a range of about 1/1000 to about 1/100 of the chord length L1 of the blade 1. When the thickness T is defined within the above range, a structural shape change due to plastic deformation or damage may be prevented without significantly affecting an air flow of the blade 1.

According to an embodiment of the present disclosure, the attachment unit 10 may include an attachment surface 11 attached to the trailing edge 3 of the blade 1 and an inclined surface 12 inclined at a certain angle 8 from an end portion of the attachment surface 11.

The inclined surface 12 may be arranged to reduce an effect of the attachment unit 10 when the blade 1 rotates, and the attachment surface 11 and the inclined surface 12 may form an angle of about 8° to about 11°. In other words, the inclined surface 12 may extend while forming an angle in a range of the above-described angle from an end of the attachment surface 11.

As illustrated in FIGS. 3 and 4, the sawtooth unit 20 may be provided to decompose the vortex separating from the trailing edge 3 of the blade 1, and to reduce the strength of the decomposed vortex. The sawtooth unit 20 may protrude from the attachment unit 10 in a longitudinal direction of the attachment unit 10 (defined as being the same as a chord length direction). The sawtooth unit 20 may protrude from an end portion of the attachment unit 10 in a direction away from the trailing edge 3 of the blade 1.

According to an embodiment of the present disclosure, the sawtooth unit 20 may include a lower sawtooth unit 21 and an upper sawtooth unit 22.

The lower sawtooth unit 21 may include a plurality of first sawteeth 211 repeatedly arranged. In other words, in the lower sawtooth unit 21, the plurality of first sawteeth 211 may be repeatedly arranged at a constant interval from each other. According to the embodiment, a length TL1 of the first sawtooth 211 may be the same as the length L2 of the attachment unit 10.

The first sawtooth 211 may include a first attachment unit 212 and a first protrusion unit 213.

The first attachment unit 212 may be a portion, where each first sawtooth 211 is attached to the attachment unit 10. The first attachment unit 212 may correspond to a root of the first sawtooth 211. The first protrusion unit 213 may be a portion protruding from the first attachment unit 212 in a triangular shape. According to the embodiment, the first protrusion unit 213 may be formed in an isosceles triangle, and an end of the first sawtooth 211 may be formed sharp.

The upper sawtooth unit 22 may include a second sawtooth 221 formed to have a length shorter than the length TL1 of the first sawtooth 211 on each upper surface of the first sawtooth 211. The second sawtooth 221 may be a multi-sawteeth, in which at least two identical sawteeth are repeated. According to the embodiment, the second sawtooth 221 including two identical sawteeth may be seated on each first sawtooth 211.

According to the embodiment, a length TL2 of the second sawtooth 221 may be about 4/10 to about 6/10 of the length TL1 of the first sawtooth 211. More preferably, the length TL2 of the second sawtooth 221 may be about 1/2 of the length TL1 of the first sawtooth 211. For example, when the length TL1 of the first sawtooth 211 is about 10 cm, the length TL2 of the second sawtooth 221 may be about 5 cm.

In addition, a period λ, in which the second sawtooth 221 is arranged, may be formed within about 3/10 of the length TL1 of the first sawtooth 211. As illustrated in FIG. 3, the second sawtooth 221 according to the embodiment may include a multi-sawteeth having with two teeth, and the period λ of the multi-sawteeth on the upper surface of the first sawtooth 211 may be given as about 3/10 of the length TL1.

For example, when the length TL1 of the first sawtooth 211 is about 10 cm, the period λ of the multi-sawteeth may be about 3 cm. As described above, when the period λ of the second sawtooth 221 is designed to be within about 3/10 of the length TL1 of the first sawtooth 211, it has been confirmed that the second sawtooth 221 has an effective noise reduction effect.

According to the embodiment, the second sawtooth 221 may include a left sawtooth 222 having a triangular shape and including a vertex above one edge of the first protrusion unit 213, and a right sawtooth 223 having a triangular shape and including an vertex above the other edge of the first protrusion unit 213.

The left sawtooth 222 may include a second coupling unit 224 coupled to the attachment unit 10 and a second protrusion unit 225 protruding in a triangular shape from the second coupling unit 224. A vertex of the left sawtooth 222 may be on one side of an isosceles triangle forming the first protrusion unit 213, and the left sawtooth 222 may be formed in an isosceles triangle shape.

Similarly, the right sawtooth 223 may include a third coupling unit 226 coupled to the attachment unit 10 and a third protrusion unit 227 protruding in a triangular shape from the third coupling unit 226. A vertex of the right sawtooth 223 may be on the other side of an isosceles triangle forming the first protrusion unit 213, and the right sawtooth 223 may be formed in an isosceles triangle shape. The left sawtooth 222 and the right sawtooth 223 may be arranged symmetrically on the upper surface of the first sawtooth 211.

Hereinafter, an action or effect of the blade noise reduction apparatus 100 according to the above-described configuration will be described in detail.

When the blade 1 rotates, the air may flow toward the trailing edge 3 along a surface of the blade 1 having a streamlined shape, and as the air is separated from the trailing edge 3 of the blade 1, a vortex may be generated. The blade noise reduction apparatus 100 according to an embodiment of the present disclosure may reduce noise by using processes of decomposing and offsetting the vortex.

The vortex generated while the air retreats toward the trailing edge 3 may, as illustrated in FIG. 5, be decomposed by the upper sawtooth unit 22 and the lower sawtooth unit 21. As the air flows toward the trailing edge 3 of the blade 1, the vortex may be roughly decomposed into a first decomposed vortex 31, which is decomposed between the plurality of first sawteeth 211 a second decomposed vortex 32, which is decomposed while the air flows between the multi-sawteeth of the second sawtooth 221, and a third decomposed vortex 33, which is decomposed as the air departs at the tip of the first sawtooth 211. Particularly, the vortex may be decomposed into smaller vortices while flowing from the attachment unit 10 to the tip of the first sawtooth 211. In other words, the magnitude of the vortex may decrease in the order of the first decomposition vortex, the second decomposition vortex, and the third decomposition vortex, and the strength of the vortices may be decreased accordingly.

The vortices decomposed as described above may be offset due to an interference phenomenon between them. As illustrated in FIG. 6, vortices formed around a pair of the left and right sawteeth 222 and 223 formed on the upper surface of the first sawtooth 211 and facing each other may rotate while surrounding a thickness direction of the second sawtooth 221, and because the left and right sawteeth 222 and 223 of second sawteeth 221 are formed facing each other, rotation directions of adjacent vortices may be opposite to each other and generate an offsetting effect to each other (refer to R1 in FIG. 6).

In addition, vortices between the tips of the first sawteeth 211 and tips of the second sawteeth 221 may flow in a direction of surrounding the first sawtooth 211. In other words, as illustrated in FIG. 6, a vortex rotating from a bottom to a top of both sides of the isosceles triangle may be formed. Accordingly, directions of the vortices on the upper surface of the first sawtooth 211 may be opposite to each other, and thus, the vortices may cause an offsetting effect (refer to R2 in FIG. 6).

FIG. 7 is a table, in which magnitudes of sound for frequencies are recorded for a case where the blade noise reduction apparatus 100 according to an embodiment of the present disclosure has been applied and for a case where it has not been applied. FIG. 8 is a graph representing data of FIG. 7. As shown in FIG. 8, a maximum noise of about 63.08 dBA has been recorded in a blade, in which the sawtooth structure has not been combined, and when the blade noise reduction apparatus 100 according to the present disclosure is applied, a maximum noise of about 58.10 dBA has been recorded and thus, a maximum noise reduction effect of about 5 dBA has been identified.

In this manner, the blade noise reduction apparatus 100 according to an embodiment of the present disclosure may decompose the vortices generated at the trailing edge 3 of the blade 1, and reduce noise generated at the trailing edge 3 of the blade 1 by forming small vortices having opposite directions to each other from the decomposed vortices and offsetting the decomposed vortices.

FIG. 9 is a diagram illustrating a case, in which an upper sawtooth unit 22′ combined to a lower sawtooth unit 21′ is not an isosceles triangle. Both of two sawteeth (the upper sawtooth unit 22′) arranged on the lower sawtooth unit 21′ may not be isosceles triangles. In this case, when the air flows from top to bottom with reference to FIG. 9, the effect of vortex decomposition and extinction may be significantly reduced due to an asymmetrical structure of the upper sawtooth unit 22′. Therefore, as illustrated in the embodiments of the present disclosure, it may be desirable to form the left sawtooth 222 and the right sawtooth 223 constituting the upper sawtooth unit 22 in an isosceles triangle shape.

The blade noise reduction apparatus according to the present disclosure may reduce noise generated at a trailing edge of a blade by decomposing vortices generated at the trailing edge of the blade and reducing the vortices by forming smaller vortices having opposite directions to each other from the decomposed vortices.

Although the present disclosure has been described in detail with reference to the embodiments, the present disclosure is not limited thereto, and various modifications thereto may be provided without departing from the scope of the present disclosure.

1. A blade noise reduction apparatus arranged at a trailing edge of a blade to reduce noise during rotation of the blade, the apparatus comprising:
an attachment unit combined with the trailing edge of the blade; and
a sawtooth unit formed to protrude in a longitudinal direction of the attachment unit from the attachment unit,
wherein the sawtooth unit comprises:
a lower sawtooth unit including first sawteeth repeatedly arranged thereon; and
an upper sawtooth unit including a second sawtooth having a length less than a length of the first sawtooth and arranged on an upper surface of each first sawtooth.

2. The apparatus of claim 1, wherein the second sawtooth comprises a multi-sawteeth formed by at least two repeating identical sawteeth.

3. The apparatus of claim 1, wherein a length of the attachment unit is greater than or equal to about 1/10 of a chord length of the blade.

4. The apparatus of claim 1, wherein a thickness of the attachment unit is within a range of about 1/1,000 to about 1/100 of the chord length of the blade.

5. The apparatus of claim 1, wherein
the attachment unit comprises an inclined surface extending by a certain angle from one end portion of an attachment surface contacting the trailing edge of the blade, and
the certain angle formed between the inclined surface and the attachment surface is within a range of about 8° to about 11°.

6. The apparatus of claim 1, wherein the length of the first sawtooth is equal to the length of the attachment unit.

7. The apparatus of claim 1, wherein the length of the second sawtooth is about 4/10 to about 6/10 of the length of the first sawtooth.

8. The apparatus of claim 1, wherein an interval between the second sawteeth is within about 3/10 of the length of the first sawtooth.

9. The apparatus of claim 1, wherein
each first sawtooth comprises a first attachment unit contacting the attachment unit and a first protrusion unit protruding from the first attachment unit in a triangle shape, and
the second sawtooth comprises a left sawtooth in a triangle shape of which vertex is arranged on one side edge of the first protrusion unit, and a right sawtooth in a triangle shape of which vertex is arranged on the other side edge of the first protrusion unit.

10. The apparatus of claim 9, wherein each of the left sawtooth and the right sawtooth has an isosceles triangle shape.
